(19) United States
(12) Patent Application Publication
(10) Pub. No.: US 2009/0234579 A1
(43) Pub. Date: Sep. 17, 2009

(54) SYSTEMS OF POINTS OF INTEREST IN SATELLITE NAVIGATION SYSTEM APPLICATIONS

(76) Inventors: James WANG, San Jose, CA (US); Bo YU, Chengdu (CN)

Correspondence Address: PATENT PROSECUTION;O2MIRCO , INC., 3118 PATRICK HENRY DRIVE, SANTA CLARA, CA, 95054, US

(21) Appl. No.: 12/401,804

(22) Filed: Mar. 11, 2009

Related U.S. Application Data
(60) Provisional application No. 61/069,121, filed on Mar. 12, 2008.
(60) Provisional application No. 61/070,302, filed on Mar. 21, 2008.

(51) Int. Cl. G01C 21/32; G01C 21/00; G06F 17/30

(52) U.S. Cl. 701/208; 701/213; 707/3; 707/104.1; 709/230; 707/E17.108; 707/E17.018; 707/E17.005; 707/200

(57) ABSTRACT

A system includes a point of interest (POI) database and a power engine. The POI database is used for storing a plurality of POIs used for a satellite navigation system (SNS). The power engine is coupled to the POI database for searching a plurality of desired POIs from the POI database and downloading the desired POIs as a plurality of downloaded POIs to a terminal device via a network. The power engine also receives a modified POI from the terminal device via the network and updates the POI database by uploading the modified POI to the POI database.

### RELATED APPLICATION

This application claims priority to U.S. Provisional Application No. 61/069,121, filed on Mar. 12, 2008 and U.S. Provisional Application No. 61/070,302, filed on Mar. 21, 2008, which are hereby incorporated by reference in their entirety.

### BACKGROUND

Point of interest (POI) is a specific point location which is widely used for satellite navigation system (SNS), such as the global positioning system (GPS). A GPS POI comprises latitude and longitude information of an interest point. A name and/or description for the interest point can also be included. Other information, such as a category or a telephone number might also be attached. GPS applications can use icons to represent different categories of POIs on a map graphically.

As GPS-enabled devices as well as software applications that use digital maps become more and more popular, the applications for POIs are also expanding. POIs can be used to represent various kinds of information such as shopping stores, hospitals, gas stations, restaurants, tourist activities, attractions, parks, etc. However, POIs in conventional GPS devices may not be complete and may also include wrong/outdated information that might mislead the users.

### SUMMARY

In one embodiment, a system includes a point of interest (POI) database and a power engine. The POI database is used for storing a plurality of POIs used for a satellite navigation system (SNS). The power engine is coupled to the POI database for searching a plurality of desired POIs from the POI database and downloading the desired POIs as a plurality of downloaded POIs to a terminal device via a network. The power engine also receives a modified POI from the terminal device via the network and updates the POI database by uploading the modified POI to the POI database.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 is a block diagram showing a POI information system, in accordance with one embodiment of the present invention.

FIG. 2 is a block diagram showing a POI information system, in accordance with another embodiment of the present invention.

FIG. 3 is a flowchart showing operations performed by a POI information system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities Unless specifically stated otherwise as apparent from the following discussions, it is appreciated that throughout the present application, discussions utilizing the terms such as “generating,” “uploading,” “updating,” “downloading,” “combining,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to an embodiment of the present invention, a system of POI is provided. In one such embodiment, the system of POI has an open structure and can be accessed by a terminal device via a network. As such, the terminal device not only can download the POI information but also can supplement and modify/update the POIs in the system. Consequently, performance of the SNS applications employing the POI system can be improved.

Embodiments according to the invention are discussed in the context of a GPS system; however, the invention is not so limited. In general, the invention is well-suited for use with other types of satellite navigation systems.

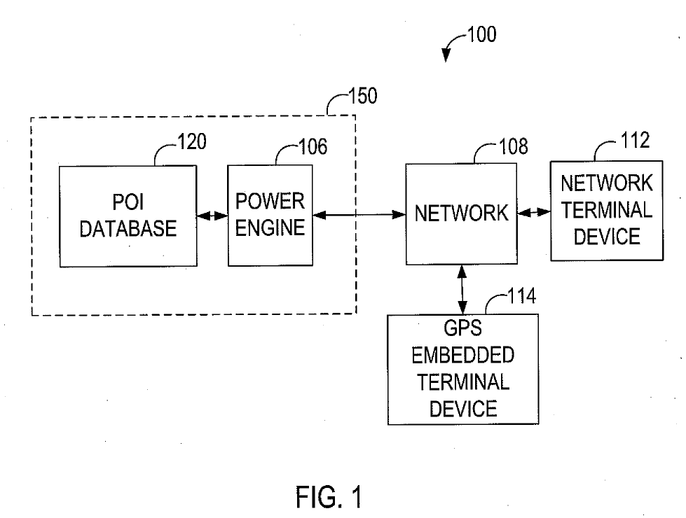

Referring to FIG. 1, a POI information system 100 according to one embodiment of the present invention is illustrated. The POI information system 100 includes a system 150, a network 108, e.g. the Internet, coupled to the system 150, and one or more terminal devices. In one embodiment, the terminal device can be a network terminal device 112 or an SNS embedded terminal device, e.g. a GPS embedded terminal device 114. The network terminal device 112 and the GPS embedded terminal device 114 can be coupled to and communicate with the network 108.

The network terminal device 112 and the GPS embedded terminal device 114 are operable for communicating with the system 150 via the network 108, downloading the POIs from the system 150 via the network 108 as downloaded POIs, and uploading a new/modified POI to the system 150 via the network 108. In other words, a new POI can be added into the system 150 and an existing POI in the system 150 can also be modified by the terminal device.

The network terminal device 112 is a terminal device such as a notebook, a cell phone or a personal digital assistant (PDA) which can access the network 108 and communicate with other devices coupled to the network 108. The GPS embedded terminal device 114 is a terminal device which can access the system 150, and send a first SNS signal (e.g., a GPS signal) to an SNS (e.g., a GPS) and receive a second SNS signal from the SNS. In one embodiment, the GPS embedded terminal device 114 has a GPS function to determine position, speed, direction, and/or time, etc. of the GPS embedded terminal device 114 via GPS signals. In one embodiment, the GPS embedded terminal device 114 can be, but is not limited to, a GPS embedded notebook, a GPS embedded cell phone, or a GPS embedded PDA.

The system 150 can be used to store the POIs, provide the POIs, and receive the new/modified POI from the network terminal device 112 and/or the GPS embedded terminal device 114 via the network 108, and update the system 150 according to the new/modified POI. In one embodiment, the system 150 includes a POI database 120 and a power engine 106.

The POI database 120 can be used to store the POIs and corresponding information associated with POIs. In one embodiment, POI information stored in the POI database 120 can include, but is not limited to, the position information of a corresponding POI, such as latitude, longitude, and altitude information, the address of the POI, the website of the POI, the picture of the POI, and the description of the POI. Furthermore, the POIs can be classified into different countries or categories, such as shopping stores, hospitals, gas stations, restaurants, tourist activities, parks as well as other categories.

The power engine 106 can serve as an interface for communicating with the network terminal device 112 and/or the GPS embedded terminal device 114. In one embodiment, the power engine 106 communicates with the POI database 120 according to Structured Query Language (SQL) protocol. In one embodiment, the network terminal device 112 can communicate with the power engine 106 via the network 108 according to the Hypertext Transfer Protocol (HTTP). The GPS embedded terminal device 114 can also communicate with the power engine 106 via the network 108.

In one embodiment, the power engine 106 can also upload the new/modified POI to the POI database 120, search POIs in the POI database 120, and download POIs from the POI database 120.

According to an embodiment of the present invention, the POI database 120 accompanied by the power engine 106 has an open architecture. The network terminal device 112 and/or the GPS embedded terminal device 114 can search desired POIs and download the desired POIs from the POI database 120 via the network 108. Furthermore, the power engine 106 can receive the new/modified POI from the network terminal device 112 and/or the GPS embedded terminal device 114, and update the POI database 120 by uploading the new/modified POI to the POI database 120. In one embodiment, the network terminal device 112 and/or the GPS embedded terminal device 114 can transfer the new/modified POI to the power engine 106 according to the Hypertext Transfer Protocol (HTTP). As such, the network terminal device 112 and/or the GPS embedded terminal device 114 can be used to supplement and revise the POIs in the system 150 and therefore updating the POI information system 100 timely. As a result, performance of SNS applications employing the POI information system 100 can be improved.

In one embodiment, the new/modified PO can be uploaded to the POI database 120 by a user anonymously. The POIs stored in the POI database 120 can also be downloaded by the user anonymously. In other words, no account registration is needed for users to access the POI database 120, in one embodiment. In another embodiment, a user account is registered for the user to access the POI database 120. In both circumstances, the new/modified POI can be stored and updated in the POI database 120 and the POI database 120 can be accessed.

In one embodiment, no review process is needed before the new/modified POI is input and updated to the POI database 120. In another embodiment, to improve the quality, the new/modified POI is reviewed according to certain protocols or standards before it is input to the POI database 120. More specifically, the system 150 can rely on some specific policies/standards to prevent vandalism or identify/fix problems and factual errors of the POIs.

For purposes of illustrating the POIs uploading process, assuming that the new/modified POI is a gas station, the corresponding information of the gas station can be input to the network terminal device 112 and/or the GPS embedded terminal device 114, and such information can be uploaded/transferred to the POI database 120 via the network 108 and the power engine 106. In one embodiment, the new/modified POI can be uploaded as a document in a specific format and can include, but is not limited to, latitude, longitude, altitude, name, website, picture, telephone, and category information of the POI.

In one embodiment, the network terminal device 112 can upload the new/modified POI to the POI database 120. For example, the information of the new/modified POI can be input to the network terminal device 112, e.g., by a user, and the network terminal device 112 can transfer the information of the new/modified POI to the POI database 120 via the network 108 and the power engine 106. In one embodiment, the new/modified POI can be uploaded as a specific format document to the system 150 according to the Hypertext Transfer Protocol (HTTP).

In one embodiment, the GPS embedded terminal device 114 can generate the current position according to the GPS signals and upload the current position to the system 150. For example, if the GPS embedded terminal device 114 is positioned at a gas station, the GPS embedded terminal device 114 can generate the position information of the gas station through the GPS signals, and the position information of the gas station can be uploaded through the GPS embedded terminal device 114 via the network 108 and the power engine 106 to the POI database 120. In another embodiment, a GPS embedded standalone device (not shown) which is not coupled to the network 108, can record or store the information of the gas station as the new/modified POI, and transmit the new/modified POI to a terminal device which can access the network 108 to upload the new/modified POI, such as the network terminal device 112 or the GPS embedded terminal device 114.

If the POIs are to be downloaded from the system 150, a POI search can be initiated by inputting a search term to the network terminal device 112 or the GPS embedded terminal device 114. The search term may include index keywords, such as a country name, a zip code or a particular category. As a result, the desired POIs stored in the POI database 120 can be searched through the power engine 106 and downloaded in a specific format document to the network terminal device 112 and/or the GPS embedded terminal device 114. In one embodiment, the specific format document can be read and modified by the network terminal device 112 or the GPS embedded terminal device 114. The specific format document can also be displayed graphically on the screen of the GPS embedded terminal device 114 by employing the embedded GPS.

In one embodiment, besides the search term, position information (e.g., the latitude, longitude, and altitude information) can also be input into the system 150 by the network embedded terminal device 112 and/or the GPS embedded terminal device 114 to initiate the POI search. As a result, the network embedded terminal device 112 and/or the GPS embedded terminal device 114 can obtain information (e.g., addresses, websites, pictures, etc.) of a preset number of desired POIs within a preset distance from the input position. For example, by inputting the latitude and longitude information of the GPS embedded terminal device 114 and the search term, the GPS embedded terminal device 114 can obtain information of a preset number of desired POIs within a preset distance from the current position of the GPS embedded terminal device 114.

In one embodiment, navigation to the desired POIs can be enabled by the GPS embedded terminal device 114 by receiving and sending GPS signals. After the preset number of desired POIs within a preset distance from the current position of the GPS embedded terminal device 114 are searched and downloaded, the navigation information to the desired POIs can be shown on the screen of the GPS embedded terminal device 114 by sending the first SNS signal (e.g., the GPS signal) to the SNS (e.g., the GPS) and receiving the second SNS signal from the SNS, in one embodiment.

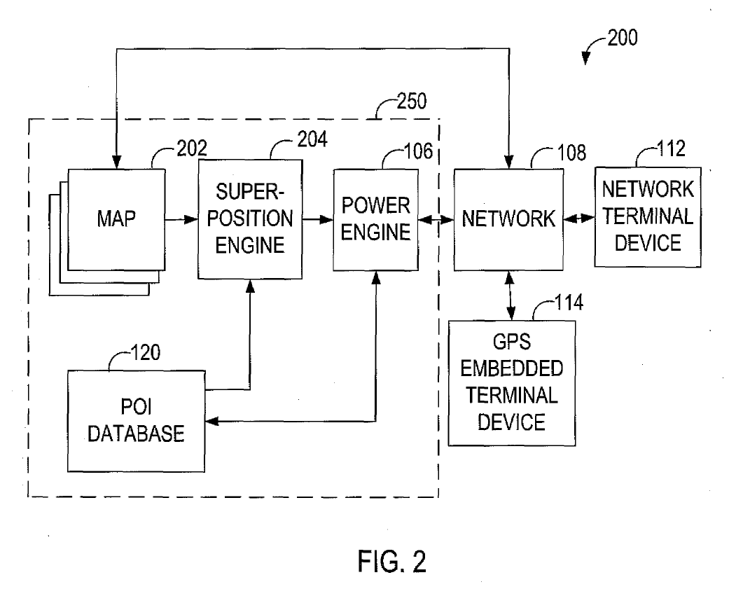

Referring to FIG. 2, a POI information system 200 according to one embodiment of the present invention is illustrated. Elements in FIG. 2 labeled the same in FIG. 1 have similar functions. The POI information system 200 includes a system 250, the network 108 coupled to the system 250 and one or more terminal devices. In one embodiment, the terminal device can be the network terminal device 112 or the GPS embedded terminal device 114.

In one embodiment, the system 250 includes a map database 202, a superposition engine 204, the power engine 106, and the POI database 120.

The map database 202 stores digital maps based on latitude and longitude coordinates. The digital maps can include road information, topography information, and the like. In one embodiment, similar to the POI database 120, the map database 202 is also an open database which can be accessed and updated by the network terminal device 112 and/or the GPS embedded terminal device 114. In other words, the map database 202 with the open architecture can provide the digital maps to the network terminal device 112 and/or the GPS embedded terminal device 114 via the network 108, and the network terminal device 112 and/or the GPS embedded terminal device 114 can upload a modified digital map via the network 108 to update the map database 202.

The superposition engine 204 can be used to combine at least one of the digital maps in the map database 202 with the desired POIs in the POI database 120 to output a POI digital map. On the POI digital map, the desired POIs in the POI database 120 can be shown on the map at corresponding positions, e.g., at corresponding latitudes and longitudes.

In one embodiment, the POIs are shown as different icons according to different categories on the POI digital map. For example, one type of icon can be used to indicate restaurants and another type of icon can be used to stand for hospitals.

The uploading process of the POIs to the system 250 is similar to the uploading process to the system 150. If the POIs are to be downloaded from the system 250, a POI search can be initiated by inputting the search term into the system 250 by the network terminal device 112 and/or the GPS embedded terminal device 114. As a result, the POI digital map marked with the downloaded POIs at corresponding positions can be displayed graphically on the screen of the network terminal device 112 and/or the GPS embedded terminal device 114, in one embodiment.

In one embodiment, besides the search term, position information can also be input into the system 150 to initiate the POI search by the network embedded terminal device 112 and/or GPS embedded terminal device 114. As a result, a POI digital map is generated, on which a preset number of desired POIs within a preset distance from the input position are marked. In one embodiment, the POI digital map marked with the desired POIs can be downloaded to the network embedded terminal device 112 and/or GPS embedded terminal device 114.

For example, the GPS embedded terminal device 114 can be used to initiate the POI search by inputting the current position of the GPS embedded terminal device 114 and the search term. The desired POIs can be downloaded to the GPS embedded terminal device 114. For example, by inputting the latitude and longitude information of the current position of the GPS embedded terminal device 114 and the search term, a POI digital map is generated, on which a preset number of desired POIs within a preset distance from the current position of the GPS embedded terminal device 114 are marked.

The system 250 can be compatible with different requirements. For example, the POIs in the POI database 120 of the system 250 can also be transmitted to the network terminal device 112 and/or the GPS embedded terminal device 114 via a specific formatted document without incorporating the digital maps in the map database 202. In this situation, the superposition engine 204 and the map database 202 are not activated during the searching and downloading process.

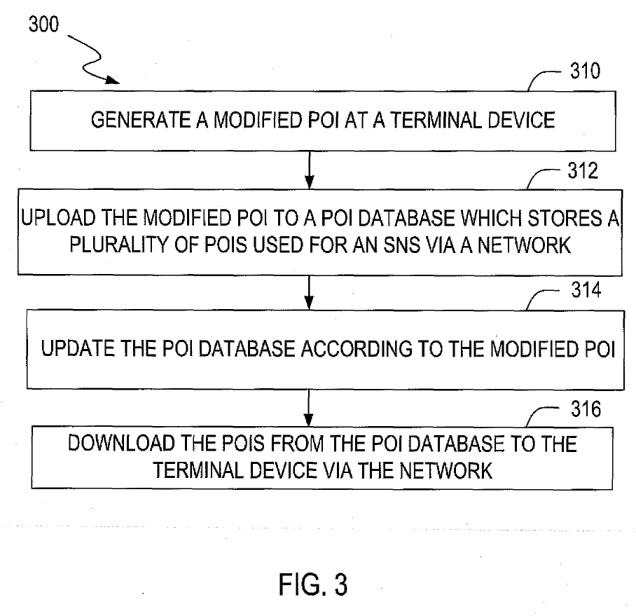

Referring to FIG. 3, a flowchart 300 showing operations performed by the POI information system 100 in FIG. 1 and/or the POI information system 200 in FIG. 2, in accordance with one embodiment of the present invention is illustrated. FIG. 3 is described in combination with FIG. 1 and FIG. 2.

At 310, a new/modified POI is generated at a terminal device (e.g., the network terminal device 112 or the GPS embedded terminal device 114). For example, if the GPS embedded terminal device 114 is positioned at a gas station, the GPS embedded terminal device 114 can generate the position information of the gas station through GPS signals as a new/modified POI. In another embodiment, a GPS embedded standalone device (not shown) which is not coupled to the network 108, can record or store the information of the gas station as the new/modified POI.

At 312, the new/modified POI is uploaded to the POI database 120 which stores the POIs used for the SNS via a network 108. For example, the new/modified POI provided by the network terminal device 112 or the GPS embedded terminal device 114 can be uploaded/transferred to the POI database 120 via the network 108 and the power engine 106.

At 314, the POI database 120 is updated according to the new/modified POI. The power engine 106 can receive the new/modified POI from the network terminal device 112 and/or the GPS embedded terminal device 114 and update the POI database 120 by uploading the new/modified POI to the POI database 120.

At 316, the POIs are downloaded from the POI database 120 to the network terminal device 112 and/or the GPS embedded terminal device 114 via the network 108. The POIs can be searched in the system 150 by inputting a search term to the network terminal device 112 or the GPS embedded terminal device 114. Subsequently, the desired POIs stored in the POI database 120 can be downloaded through the power engine 106 in a specific format document to the network terminal device 112 and/or the GPS embedded terminal device 114. The specific format document can be read and modified by the network terminal device 112 or the GPS embedded terminal device 114. The specific format document can also be displayed graphically on the screen of the GPS embedded terminal device 114 by employing the embedded GPS. In one embodiment, a POI digital map generated by the system 250 can be downloaded and shown on the screen of the network terminal device 112 and/or the GPS embedded terminal device 114, in one embodiment. On the POI digital map, the desired POI can be shown on the map at corresponding positions.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A system comprising:
a point of interest (POI) database for storing a plurality of POIs used for a satellite navigation system (SNS); and
a power engine coupled to said POI database for searching a plurality of desired POIs from said POI database and downloading said desired POIs to a terminal device via a network as a plurality of downloaded POIs, for receiving a modified POI from said terminal device via said network, and for updating said POI database by uploading said modified POI to said POI database.

2. The system of claim 1, wherein said downloaded POIs comprise a specific formatted document.

3. The system of claim 2, wherein said specific formatted document is capable of being graphically displayed by an SNS embedded terminal device.

4. The system of claim 2, wherein said specific formatted document is capable of being modified by a network terminal device.

5. The system of claim 1, wherein said downloaded POIs are marked on a POI digital map at a plurality of corresponding positions.

6. The system of claim 5, wherein said system further comprising:
a map database for storing a plurality of digital maps; and
a superposition engine coupled to said map database, said power engine and said POI database for combining said desired POIs with at least one of said digital maps stored in said map database and for generating said POI digital map.

7. The system of claim 6, wherein said map database is capable of providing said digital maps to said terminal device, and wherein said terminal device is capable of uploading a modified digital map via said network to update said map database.

8. The system of claim 1, wherein said terminal device comprises a network terminal device capable of communicating with said power engine via said network according to Hypertext Transfer Protocol (HTTP).

9. The system of claim 1, wherein said terminal device comprises an SNS embedded terminal device capable of communicating with said power engine via said network.

10. The system of claim 1, wherein said power engine communicates with said POI database according to Structured Query Language (SQL) protocol.

11. The system of claim 1, wherein said terminal device transfers said modified POI to said power engine according to Hypertext Transfer Protocol (HTTP).

12. A point of interest (POI) information system, comprising:
a system for storing a plurality of POIs, for providing said POIs and for receiving a modified POI via a network and for updating said system according to said modified POI; and
at least one terminal device operable for communicating with said system via said network, for downloading said POIs from said system via said network as a plurality of downloaded POIs, and for uploading said modified POI to said system via said network.

13. The POI information system of claim 12, wherein said system comprises:
a POI database for storing said POIs; and
a power engine coupled to said POI database for searching a plurality of desired POIs from said POI database and downloading said desired POIs to said terminal device via said network as said downloaded POIs, for receiving said modified POI from said terminal device via said network, and for updating said POI database by uploading said modified POI to said POI database.

14. The POI information system of claim 12, wherein said downloaded POIs comprise a specific formatted document.

15. The POI information system of claim 12, wherein said downloaded POIs are marked on a digital map at a plurality of corresponding positions.

16. The POI information system of claim 15, wherein said system further comprises:
a map database for storing a plurality of digital maps; and
a superposition engine coupled to said map database, said power engine and said POI database for combining said desired POIs with at least one of said digital maps stored in said map database and for generating said POI digital map.

17. The POI information system of claim 16, wherein said map database is capable of providing said digital maps to said terminal device, and wherein said terminal device is capable of uploading a modified digital map via said network to update said map database.

18. The POI information system of claim 12, wherein said terminal device comprises a satellite navigation system (SNS) embedded terminal device for accessing said system and for sending a first SNS signal to an SNS and receiving a second SNS signal from said SNS.

19. The POI information system of claim 18, wherein said POI information system is capable of enabling navigation to said desired POIs by sending said first SNS signal and receiving said second SNS signal.

20. A method comprising:
generating a modified point of interest (POI) at a terminal device;
uploading said modified POI via a network to a POI database which stores a plurality of POIs used for a satellite navigation system (SNS);
updating said POI database according to said modified POI; and
downloading said POIs from said POI database to said terminal device via said network.

21. The method of claim 20, further comprising:
combining at least one digital map with said POIs;
generating a POI digital map marked with said POIs at a plurality of corresponding positions; and
downloading said POI digital map via said network.
